(19) United States
(12) Patent Application Publication
(10) Pub. No.: US 2026/0266678 A1
(43) Pub. Date: Sep. 10, 2026

(54) STRESS-DECOUPLED MICROMECHANICAL PRESSURE SENSOR AND METHOD FOR THE PRODUCTION THEREOF

(71) Applicant: Robert Bosch GmbH, Stuttgart (DE)

(72) Inventors: Franziska Rohlfing, Leonberg (DE); Heribert Weber, Nuertingen (DE); Peter Schmollngruber, Aidlingen (DE); Sophielouise Mach, Reutlingen (DE)

(21) Appl. No.: 19/471,809

(22) PCT Filed: Mar. 11, 2024
(86) PCT No.: PCT/EP2024/056357

§ 371 Date: Oct. 2, 2025

(30) Foreign Application Priority Data
Apr. 17, 2023 (DE) 10 2023 203 438.7

(51) Int. Cl. G01L 19/14; G01L 9/00

(52) U.S. Cl. CPC G01L 19/145; G01L 9/0045; G01L 9/0073; G01L 19/147

(57) ABSTRACT

A micromechanical pressure sensor. The micromechanical pressure sensor includes: a substrate with a layer system arranged thereon; a sensor structure which is self-supportingly fastened to the layer system using at least one suspension structure and has a first membrane structure, a second membrane structure and a cavity region arranged between the two membrane structures and closed by a sidewall running in an edge region of the two membrane structures; a useful capacitor which is arranged in the cavity region between the two membrane structures and has a first electrode fastened to the first membrane structure and a second electrode arranged opposite the first electrode and fastened to the second membrane structure.

### FIELD

The present invention relates to a stress-decoupled micromechanical pressure sensor in the form of a self-supporting double membrane structure. Furthermore, the present invention also relates to a production method for such a stress-decoupled micromechanical pressure sensor.

### BACKGROUND INFORMATION

Micromechanical pressure sensors are used in various applications. Among other things, in some conventional capacitive pressure sensors, a central electrode is arranged between two membranes, this arrangement being self-supportingly fastened on at least one spring/armature structure to a silicon substrate. If such an arrangement is subjected to pressure, the membranes bend at the same time or simultaneously in the direction of the central electrode. This causes a measurable change in capacitance, which can be used to measure or determine the applied pressure. In such an arrangement, the movable electrodes of the capacitive measuring system consist of the two membranes themselves. Due to the warping of the membranes when pressure is applied, a non-linear capacitive sensor signal is generated. As a result, the pressure can only be measured linearly and with a relatively high resolution within a small pressure range.

In addition, the production of such a membrane arrangement requires that the sacrificial layer between the membranes and the central electrode is removed through holes in the uppermost membrane structure, which must subsequently be closed again. Since a certain layer thickness of sealing material is required for this purpose, the membrane thickness cannot be made thinner than this sealing layer thickness and/or the sealing material changes the flexural rigidity of the membrane structure at least locally.

### SUMMARY

An object of the present invention is to provide a possibility for realizing a stress-decoupled capacitive pressure sensor which has a high sensitivity, a linear pressure sensor signal and optional reference capacitances, which can advantageously be arranged in a space-saving manner within a cavity region. This object may be achieve by means of certain features of the present invention. Advantageous embodiments of the present invention are disclosed herein.

According to an example embodiment of the present invention, a micromechanical pressure sensor is provided which comprises a substrate with a layer system arranged thereon, and a sensor structure which is self-supportingly fastened to the layer system by means of at least one suspension structure and has a first membrane structure, a second membrane structure and a cavity region arranged between the two membrane structures and closed by a sidewall running in an edge region of the two membrane structures. In this case, the sensor structure comprises a useful capacitor structure which is arranged in the cavity region and has a first electrode preferably fastened to/in a central region of the first membrane structure and a second electrode arranged between the first electrode and the second membrane structure and preferably fastened to/in a central region of the second membrane structure.

By designing the sensor structure in the form of a self-supporting double membrane structure, stress decoupling from the surrounding layer system and the silicon substrate is achieved. This ensures that mechanical bending (e.g., due to thermal expansion) of the sensor structure no longer has any influence on the resulting sensor signal. Furthermore, due to the self-supporting design, an applied external pressure can deform both the first membrane structure and the second membrane structure. In this case, for example, the first and second electrodes, which are designed to be movable and are fastened/anchored to the first and second membrane structure, are moved toward each other. This can achieve a change in the distance between the movable electrodes that is twice as large (with identical membrane structures) when the pressure changes than with a sensor structure with only one movable electrode. In this way, in addition to stress decoupling, an increase in measurement sensitivity can also be achieved. While sensor structures with only one movable membrane require a larger and/or thinner membrane to achieve the same measurement sensitivity, or at least two smaller membrane structures must be electrically connected in a Wheatston half-bridge configuration, the same measurement sensitivity can be achieved on a significantly smaller area with the self-supporting double membrane structure. This has the advantage that the membrane structures can be made more stable for a defined pressure range and are therefore mechanically more stable against an applied overpressure. This can be further supported by the special stop structures that are fastened to the membrane structures and can prevent excessive local deformation of the membrane structures.

With the pressure measuring structure or pressure measuring arrangement according to the present invention, it can be achieved that the same comparable measurement sensitivity or measurement accuracy can be achieved on a significantly smaller area. Since the chip area makes a significant contribution to the overall cost of a sensor element, this can also be used to reduce the cost of the sensor element while maintaining at least the same performance, or the smaller space requirement can be used to provide two pressure measuring structures/pressure measuring arrangements on the original area, which make it possible to measure two pressure measuring ranges or to measure a larger pressure measuring range. A further advantage of the electrodes of the described sensor structure, which are only locally suspended on the membranes, is that a substantially linear pressure measurement signal is achieved thereby when pressure is applied. This is not the case with a sensor structure with a membrane structure that simultaneously serves as an electrode for the measurement capacitance.

Since the pressure sensor of the present invention requires a significantly smaller area for the same measurement sensitivity, it is also possible to provide two pressure sensors with double membrane structures on the area required by a comparable pressure sensor with only one membrane structure. These two pressure sensors can be constructed identically and, for example, electrically connected in a Wheatston half-bridge configuration, whereby four times the measurement sensitivity can be achieved compared to two identically connected membrane structures each with only one movable electrode structure. Furthermore, the area advantage achieved with the double membrane structure can be used to provide a further double membrane structure in addition to an already existing double membrane structure, which further double membrane structure is designed for a second pressure range, for example. In this way, the area that a pressure sensor consisting of a membrane structure or two adjacent membrane structures would require to detect/measure one pressure range can be used to detect a second or larger pressure range.

In one example embodiment of the present invention, it is provided that the electrodes are each fastened to the corresponding membrane structure by means of at least one fastening structure in an inner region of the corresponding membrane structure. This allows a particularly linear measuring behavior of the pressure sensor to be achieved.

In one example embodiment of the present invention, it is provided that at least one reference capacitor with two opposing stationary electrodes is furthermore provided in an edge region of the cavity region, each of the stationary electrodes being arranged between the other stationary electrode and one of the membrane structures. The special design of this sensor structure makes it possible to provide integrated reference capacitances, which can advantageously be arranged in a space-saving manner in a cavity region between the deformable membrane structures.

In a further example embodiment of the present invention, it is provided that the at least one reference capacitor is anchored at least partially or in regions in or on the sidewall and is self-supportingly arranged between the membrane structures, aligned plane-parallel to the membrane structures. This mechanically decouples the reference capacitor from the membrane structures to such an extent that any bending of the membrane structures as a result of an applied external pressure has no significant influence on the reference measurement.

In a further example embodiment of the present invention, it is provided that a silicon dioxide layer consisting of the material of the third silicon dioxide layer is arranged between the stationary electrodes of the reference capacitor. This allows the capacitance of the reference capacitor to be increased or, with the same capacitance, the reference capacitance structure to be reduced in area, which in turn allows the movable electrode structures of the useful capacitor to be made larger in area.

In a further example embodiment of the present invention, it is provided that at least one etching access to the cavity region is formed in the layer system, the etching access having a closure which is formed by at least one material deposited on the surface of the layer system and/or introduced into the etching access and/or by at least one locally melted and re-solidified material of the layer system.

In a further example embodiment of the present invention, it is provided that at least one etching access to the cavity region is formed in the layer system outside a deflectable sensing surface of the second membrane structure. In this case, the etching access has a closure which is formed by at least one material deposited on the surface of the layer system and/or introduced into the etching access or by a locally melted and re-solidified material of the layer system. The arrangement of the etching access outside the deflectable sensing area of the membrane structure makes it possible to precisely adjust the layer thickness and/or the mechanical properties of the membrane structure in the region of the deflectable sensing area. This allows a higher measurement accuracy of the pressure sensor to be achieved.

In a further example embodiment of the present invention, it is provided that the etching access is arranged outside the sensor structure and is connected to the cavity region by means of an etching channel running through the at least one suspension structure. This arrangement allows for a particularly large usable area of the pressure sensor.

In a further example embodiment of the present invention, it is provided that the etching access is arranged within the suspension structure. This arrangement allows the pressure sensor to require less space.

In a further example embodiment of the present invention, it is provided that the etching access is arranged in an edge region of the sensor structure. This arrangement of the etching access or the etching accesses makes better or faster etching of the sacrificial layers within the cavity possible.

In a further example embodiment of the present invention, it is provided that the sensor structure has additional anchoring structures for fastening the membrane structures, the at least one etching access being arranged between the peripheral sidewall and the additional anchoring structures. This can improve the stability of the double membrane structure and reduce or avoid any influence of the closure structure/layer, which closes the at least one etching access, on the measurement signal or the measurement behavior.

In a further example embodiment of the present invention, it is provided that the peripheral sidewall is formed by outer anchoring structures, inner anchoring structures and silicon dioxide material of the silicon dioxide layers of the layer system remaining between the outer and inner anchoring structures. The additional silicon dioxide material increases the stability of the sidewall.

In a further example embodiment of the present invention, it is provided that, in the cavity region, at least one mechanical stop structure is furthermore fastened to at least one membrane structure, which mechanical stop structure brings about a limitation of the relative movement between the two membrane structures from a specified pressure value. Such stop structures prevent excessive local deformation of the membrane structures. This protects the sensor against mechanical overload.

According to a further aspect of the present invention, a method for producing the aforementioned micromechanical pressure sensor is furthermore provided. According to an example embodiment of the present invention, in the method, a semiconductor substrate is provided and a layer structure is created on the semiconductor substrate by depositing and structuring layers. In this case, in a functional region of the layer structure, a sensor structure is created which is connected to the rest of the layer structure via a suspension structure and comprises a first membrane structure structured from a first polysilicon layer, a second membrane structure structured from a fourth polysilicon layer, and a cavity region delimited by a sidewall running in an edge region of the membrane structures. Furthermore, in this case, a useful capacitor is created in the cavity region, with a first electrode structured from a second polysilicon layer and fastened to the first membrane structure and a second electrode structured from a third polysilicon layer and fastened to the second membrane structure. Subsequently, using an etching method, silicon dioxide layers arranged in each case between the polysilicon layers in the cavity region are removed via at least one etching access having an opening in the fourth polysilicon layer. Subsequently, a first silicon dioxide layer arranged between the first membrane structure and the surface of the semiconductor substrate is removed using an etching method. The method offers the advantages mentioned above in connection with the micromechanical pressure sensor.

In one example embodiment of the present invention, it is provided that the etching access is closed by depositing at least one material on the surface of the layer system and/or by melting at least the material of the upper layers of the layer system in the region of the etching access.

In one example embodiment of the present invention, it is provided that the removal of the silicon dioxide layers in the cavity region and the removal of the first silicon dioxide layer beneath the first membrane structure are carried out in a common etching process. This can simplify the production method.

In a further example embodiment of the present invention, it is provided that trench structures are created in the surface of the semiconductor substrate beneath the sensor structure, which trench structures are not completely filled during the deposition of the first silicon dioxide layer. In this case, the trench structures cause a rapid distribution of the etching medium under the first silicon dioxide layer during the etching of the first silicon dioxide layer below the first membrane structure. This can improve or accelerate the removal of the sacrificial layer beneath the sensor structure.

The present invention is explained in more detail below with reference to figures.

### BRIEF DESCRIPTION OF THE DRAWINGS

FIG. 1 schematically shows a cross-section through a micromechanical pressure sensor according to a first embodiment of the present invention with a self-supportingly suspended double membrane sensor structure and an etching access arranged outside the sensor structure.

FIG. 2 is a schematic plan view of a micromechanical pressure sensor realized according to FIG. 1.

FIG. 3 to FIG. 7 schematically show different stages of a production method for the micromechanical pressure sensor of FIG. 1 according to the present invention.

FIG. 8 schematically shows an alternative embodiment of the micromechanical pressure sensor according to the present invention, in which the reference capacitor is filled with a dielectric.

FIG. 9 schematically shows an alternative embodiment of the unfinished pressure sensor, in which special trench structures are provided on the substrate to support the undercutting of the sensor structure.

FIG. 10 schematically shows a cross-section of a micromechanical pressure sensor according to a second embodiment of the present invention with a self-supportingly suspended double membrane sensor structure and an etching access arranged in the edge region of the sensor structure.

FIG. 11 schematically shows a cross-section through the still unfinished micromechanical pressure sensor of FIG. 10 before the undercutting of the sensor structure.

FIG. 12 is a schematic plan view of the micromechanical pressure sensor of FIG. 10.

FIG. 13 schematically shows an alternative embodiment of the micromechanical pressure sensor of FIG. 10 with a reinforced sidewall.

FIG. 14 is a simplified flow diagram of the production method, according to an example embodiment of the present invention.

### DETAILED DESCRIPTION OF EXAMPLE EMBODIMENTS

The sensor according to the present invention explained in more detail below is based on a sensing region/sensor structure suspended self-supportingly above a silicon substrate on at least one spring or anchoring structure, in which sensing region/sensor structure, however, no central electrode is provided between two deformable membranes, but rather electrode structures locally suspended on the membrane structures are provided, which electrode structures move toward each other when the membranes are deformed and do not warp or bend themselves in the process.

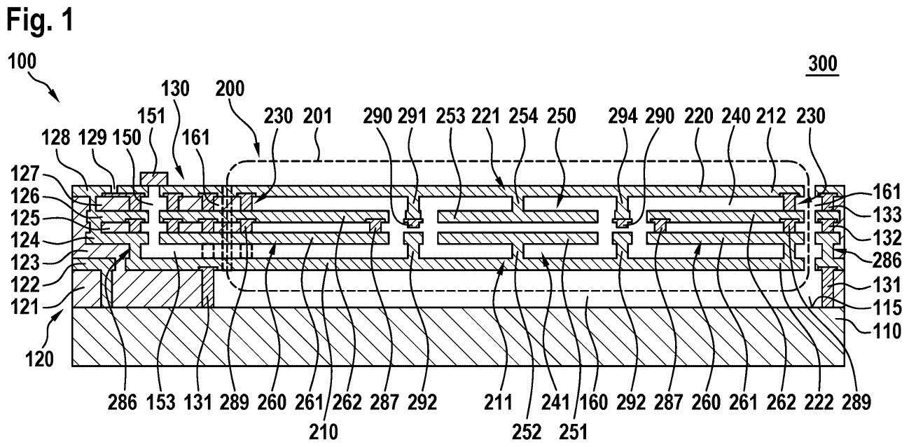

FIG. 1 shows, by way of example, a micromechanical pressure sensor 100 with a sensor structure 200 suspended self-supportingly via at least one spring or suspension structure 140. In this case, the sensor structure 200 is created in a layer system 120 arranged on a semiconductor substrate 110 and is separated from the rest of the regions of the layer system 110 by one or more separation regions 161 extending along its periphery. The separation regions are separated from the surrounding regions of the layer structure 120 by etch stop structures 286, which in the present example are formed, inter alia, by vertical regions of the layers 131, 124, 132, 133. The sensor structure 200, also referred to below as the sensing region, is a double membrane structure with a first and second membrane 210, 220 and a cavity region 240 arranged between the two membranes 210, 220. In this case, the cavity region 240 is sealed in a gas-tight manner from the environment 300 by a sidewall 230 arranged between the membrane structures 210, 220 and running along the periphery of the sensor structure 200. In this case, the sidewall 230 is formed by etch stop structures, which in the present example also serve as anchoring structures of the membranes 210, 220 and the stationary electrodes 261, 262.

In a central region 241 of the cavity region 240, a useful capacitor 250 is arranged, which comprises two movable electrodes 251, 253 arranged opposite each other at a defined distance and each fastened to one of the two membrane structures 210, 220, the first electrode 251 being arranged between the second electrode 253 and the first membrane structure 210 and the second electrode 253 being arranged between the first electrode 251 and the second membrane structure 220. In this case, the first electrode 251 is fastened to/in an inner region 211 (such as the central region) of the first membrane structure 210 by means of at least one first fastening structure 252, while the second electrode 251 is preferably fastened to or in an inner or central region 221 of the second membrane structure 220 by means of at least one second fastening structure 254. As an alternative to the exemplary embodiment shown here, in which each electrode 251, 253 is fastened by means of a fastening structure 252, 254 in the center of the corresponding membrane structure 210, 220, the fastening of the electrodes 210, 220 to the membrane structures 210, 220 can also be carried out by means of multiple fastening structures, which, depending on the design, can also be arranged in an inner region outside the exact center of the membrane structures 210, 220.

As can also be seen in FIG. 1, mechanical stop structures 290 can furthermore be located in the cavity region 240, which stop structures limit the maximum deflections of the membrane structures 210, 220 from a specifiable/definable pressure value.

In the present example, the stop structures 290 are constructed in two parts, the two complementary parts each being fastened to the membrane structures 210, 220 by means of their own anchoring structure 291, 292.

Depending on the application, at least one reference capacitor 260 can also be accommodated in the cavity region 240, which reference capacitor is preferably located in an outer region of the cavity region 240. Such a reference capacitor 260 is preferably created in the same layer plane as the useful capacitor 250 and in each case comprises a first stationary electrode 261 and a second stationary electrode 262 spaced apart therefrom at a specified distance, the first stationary electrode 261 being arranged between the second stationary electrode 262 and the first polysilicon layer 210 forming the first membrane structure 210 and the second stationary electrode 262 being arranged between the first stationary electrode 261 and the fourth polysilicon layer forming the second membrane structure 220. The two stationary electrodes 261, 262 can be electrically conductively and/or electrically isolatingly connected to each other and/or to the other layers of the sensing region 200 via separation and anchoring structures 287, 289, it also being possible for the separation and anchoring structures 287, 289 to act or serve as lateral etch stop structures.

As can also be seen in FIG. 1, the pressure sensor 100 furthermore comprises at least one etching access 150 arranged outside the sensor element 200, which etching access is connected to the cavity region 240 via at least one etching channel 153 running within the suspension structure 140. The at least one etching access 150 is sealed or closed in a media-tight manner with respect to the environment by a closure 151 so that a gas volume with a defined pressure and a defined composition is located in the cavity region 240. In principle, the etching channel can also be provided between the second and third and/or between the third and fourth polysilicon layers or levels.

During operation of the pressure sensor, the two membrane structures 210, 220 warp inward or outward depending on the pressure prevailing in the environment 300. As a result, the distance between the two movable electrodes 251, 253 of the useful capacitor 150 is reduced or increased, which is measured as a corresponding linear change in the capacitance of the useful capacitor 250. However, due to the arrangement of the stationary electrodes 261, 262 being decoupled from the bending regions of the membrane structures 210, 220, no relevant change in capacitance occurs in the reference capacitor 260.

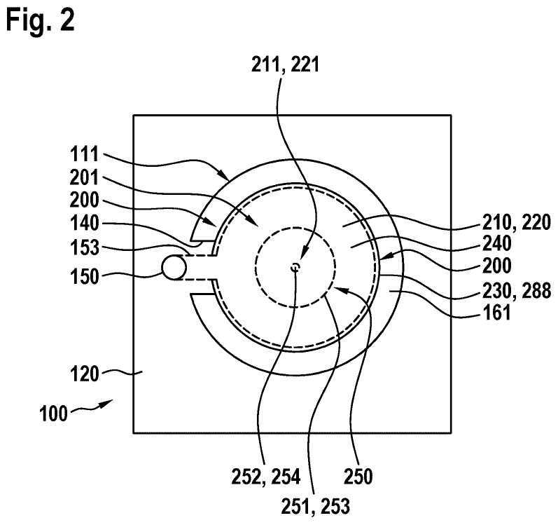

FIG. 2 is a plan view of an exemplary pressure sensor 100 with a sensing region 200 suspended spaced apart from the semiconductor substrate 110 in a stress-decoupled manner via a suspension structure 140. In the present example, the sensing region 200 is circular and is connected to a region, serving for anchoring, of the surrounding layer system via only one suspension structure.

In principle, however, the sensing region 200 can also be shaped differently, e.g., square. Furthermore, more than one suspension structure 140 may also be used to suspend the sensing region 200. In addition, the at least one suspension structure 140 can have any shape and any geometric dimensions.

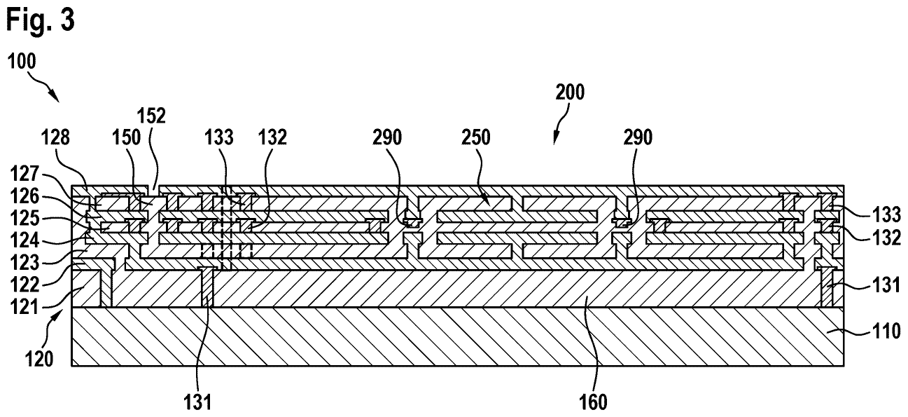

Using the following FIGS. 3 to 9, in addition to a method for producing a corresponding pressure sensor, possible alternative embodiments of the pressure sensor are also explained by way of example. In this case, FIG. 3, in which the basic structure of the underlying concept is illustrated, shows a method stage in which a layer system 120 is already arranged on the semiconductor substrate 110 (Si substrate). In order to produce the layer system 120, a first silicon dioxide layer (SiO2 layer) 121 is first created on a semiconductor substrate 110 and then structured. This first SiO2 layer 121 is later removed at least locally in order to produce a stress-decoupled and self-supporting sensing region. Subsequently, a first dielectric layer 131, such as a first SiRiN layer (silicon-rich nitride), which is resistant to a later SiO2 sacrificial layer etching process, is deposited on the first SiO2 layer 121 and structured. In this case, previously created SiO2-free regions in the first SiO2 layer 121 are at least partially filled with the first SiRiN layer 131. These filled regions can later serve, for example, as electrically isolating etch stop boundaries in a sacrificial layer etching process. After structuring the first SiRiN layer 131, further structuring of the first SiO2 layer 121 and/or the first SiRiN layer 131 is optionally carried out. In this case, contact hole structures are created, which can later be used to electrically contact the silicon substrate 110.

After the optional second structuring of the first SiO2 layer 121 and/or the first SiRiN layer 131, the first polysilicon layer 122 is deposited and structured. With the help of this first polysilicon layer 122, a first membrane structure 210 is later formed. Furthermore, further structures, such as at least one electrical substrate contact or at least one conductor track structure, can be realized with the first polysilicon layer 122.

A second SiO2 layer 123 is then created on this first polysilicon layer 122 and structured. This SiO2 layer 123 serves, among other things, as a sacrificial layer in a cavity region 240 and is later removed again in the cavity region. Subsequently, a second polysilicon layer 124 is deposited and structured. In this case, the SiO2-free regions in the second SiO2 layer 123 are at least partially filled with material of the second polysilicon layer 124. In this case, the regions thus filled in the second SiO2 layer 123 can serve to realize electrically conductive connections between the first and second polysilicon layers/levels 122, 124, lateral etch limiting structures, partial regions of later stop structures, a partial region of an anchoring structure of the first and second membrane structures 210, 220, a partial region of a sidewall 230 surrounding the cavity region 240, a partial region of an outer etch stop structure 286 and/or as anchoring structures of a later freely movable first electrode structure 251 and/or a first stationary electrode 261 of an integrated reference capacitor structure 260. The structuring of the second polysilicon layer 124 serves to produce at least one later movable first electrode structure 251. In this case, at the same time, a first conductor track structure (not shown here) and/or a first stationary electrode 261 of the reference capacitor structure 260 can also be created.

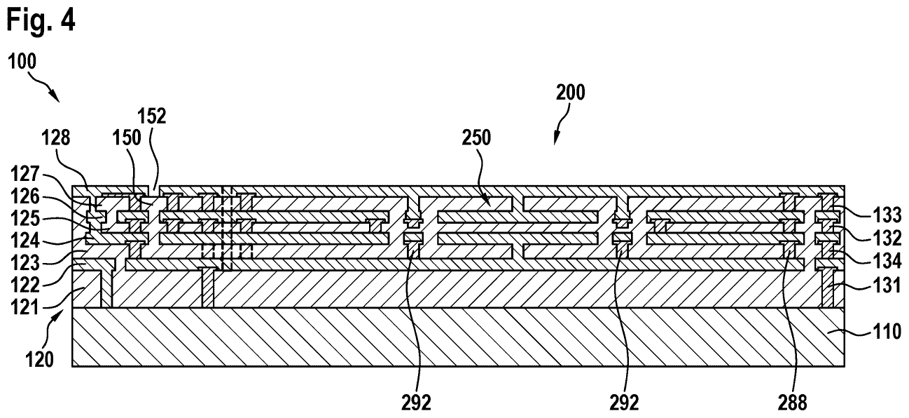

Alternatively, before the deposition of the second polysilicon layer 124, at least one further structuring of the second SiO2 layer 123 as well as the deposition and structuring of a further SiRiN layer 134, which is at least in regions covered by the second polysilicon layer 124 or embedded therein, can be carried out (cf. FIG. 4). In this way, at least anchors of stop structures 292 in the cavity region 240 and/or lateral etch limiting structures provided between the first and second polysilicon layers/levels 122, 124 and/or anchoring structures of the later movable first electrode structure 210 and/or the stationary first electrode 261 of the reference capacitor structure 260 and/or a partial region of an anchoring structure of the first and second membrane structures 210, 220 and/or a partial region of a sidewall 230 surrounding the cavity region 240 and/or a partial region of an outer etch stop structure 286 can be designed to be electrically isolating.

A third SiO2 layer 125 is then deposited on the structured second polysilicon layer 124 and structured. This SiO2 layer 125 substantially defines the distance between the two later movable electrode structures 251, 253 of the useful capacitor 250 as well as the distance between the stationary electrodes 261, 262 of one or more optional reference capacitors 260. As described above, the stationary electrodes 261, 262 can be located at least partially in the cavity region and/or alternatively can be provided outside the cavity region 240. Alternatively, the third SiO2 layer can be designed to have different thicknesses locally/in regions, by means of an etching process and/or by depositing and structuring at least two SiO2 layers, in order to produce a different distance between the movable electrode structures 251, 253 of the useful capacitor 250 and between the stationary electrodes 261, 262 of one or more optional reference capacitors 260.

The structuring of the third SiO2 layer 125 can be carried out in such a way that the third SiO2 layer 125 is not completely removed in regions of the cavity region 240 in which knobs or vertical stop structures 290 are to be provided. The remaining thickness of the third SiO2 layer 125 can be used to adjust the maximum deflection of the membrane structures 210, 220 as a result of pressure application, i.e., how far the membrane structures 210, 220 can later move toward each other during the pressure measurement.

After structuring the third SiO2 layer 125, a second SiRiN layer 132 is deposited. In this case, in the third SiO2 layer 125, the SiO2-free regions or the depressions previously created therein are at least partially filled in order to be able to create electrically isolating etch limiting structures and/or a partial region of vertical stop structures 290 and/or anchoring structures of the stationary first and second electrodes 261, 262 of the reference capacitor structure 260 and/or a partial region of an anchoring structure of the first and second membrane structures 210, 220 and/or a partial region of a sidewall 230 surrounding the cavity region 240 and/or a partial region of an outer etch stop structure 286.

This is followed by structuring of the second SiRiN layer 132, followed by a further optional structuring of the second SiRiN layer 132 and/or the third SiO2 layer 125 for producing contact hole structures. After this process step, a third polysilicon layer 126 is deposited and structured. This third polysilicon layer 126 serves to produce a second movable electrode structure 253 of the useful capacitor 250 and a second electrode 262 of the optional reference capacitor structure 260. Furthermore, by depositing material of the third polysilicon layer 126 into corresponding contact hole structures in the third SiO2 layer 125, electrically conductive connections between the second and third polysilicon layers/levels 124, 126 and/or at least one conductor track structure can also be realized.

Alternatively, after the structuring of the second SiRiN layer 132 and/or the third SiO2 layer 125, the structures exposed in the process can be at least partially filled with material of the third polysilicon layer/level 124, 126 through the second SiRiN layer 132 and/or the third SiO2 layer 125 in order to be able to form electrical connections, lateral etch limiting structures, a partial region of later stop structures, a partial region of an anchoring structure of the first and second membrane structures 210, 220, a partial region of a sidewall 230 surrounding the cavity region 240 and/or a partial region of an outer etch stop structure 286 between the second and third polysilicon layers/levels 124, 126 in an electrically conductive manner.

In order to avoid an etching attack on the third SiO2 layer 125 during the structuring of the second SiRiN layer 132, a further polysilicon layer can be deposited on the third SiO2 layer 125 before the deposition of the second SiRiN layer 132 and structured together with the third SiO2 layer 125. During the subsequent structuring of the second SiRiN layer 132, the etching process stops at/in the further polysilicon layer and etching of the third SiO2 layer 125 can be avoided. This is advantageous in particular since the third SiO2 layer 125 is used to define the electrode spacing and its thickness therefore determines the capacitance of the useful capacitor 250 and thus indirectly also the measurement sensitivity and the measuring range of the pressure sensor 100. Subsequently, a third polysilicon layer 126 can also be deposited here, and the third polysilicon layer 126 can be structured together with the further polysilicon layer used or serving as an etch stop.

After the structuring of the third polysilicon layer 126 together with the further polysilicon layer, a fourth SiO2 layer 127 is deposited and structured, followed by the deposition of a third SiRiN layer 133. In this case, in the fourth SiO2 layer 127, previously created SiO2-free regions are at least partially filled with a third SiRiN layer 133. These filled regions can later serve, for example, as electrically isolating etch stop boundaries in a sacrificial layer etching process. After the structuring of the third SiRiN layer 133, further structuring of the fourth SiO2 layer 127 and/or the third SiRiN layer 133 is optionally carried out. In this case, contact hole structures, partial regions of later stop structures and/or anchoring structures are created, which can later serve for electrical contacting between the third and fourth polysilicon layers/levels 126, 128, for mechanically suspending a movable electrode on the second membrane structure, as lateral etch stop structures, as a partial region of an anchoring structure of the first and second membrane structures 210, 220, as a partial region of a sidewall 230 surrounding the cavity region 240 and/or as a partial region of an outer etch stop structure 286.

After the production of these structures, a fourth polysilicon layer 128 is deposited and structured. In this case, at least partially SiO2-free regions in the fourth SiO2 layer 127 are filled and the aforementioned structures consisting of material of the fourth polysilicon layer 128 are created. The fourth polysilicon layer 128 also serves to realize the second membrane structure 220 and to produce at least one electrical conductor track structure (not shown here). During the structuring of the fourth polysilicon layer 128, isolation trenches can be created, such as inter alia also the isolation trench 129 shown in FIG. 3 and used for the electrical isolation of the second membrane structure 220. Afterwards, further layer depositions can be carried out, which are not shown in detail here in FIG. 3. They can be used, for example, to produce bond pad structures, electrical conductor tracks and isolation structures for their electrical isolation and/or to produce diffusion barriers, which are used, for example, as moisture barriers.

Alternatively, after the deposition of a fourth SiO2 layer 127 and the deposition of a third SiRiN layer 133, the structuring of the fourth SiO2 layer 127 and the third SiRiN layer 133 can be carried out in such a way that the aforementioned structures consist of the material of the fourth polysilicon layer 128. In this case, the elements/structures formed between the third and fourth polysilicon layers/levels 126, 128 are preferably formed to be electrically conductive.

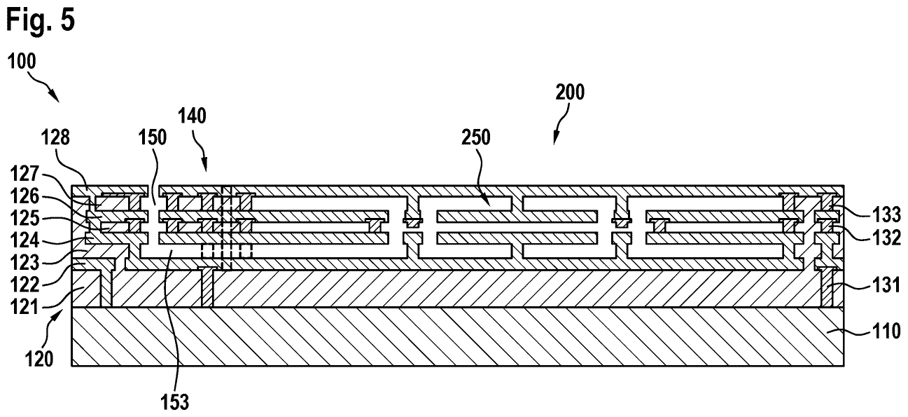

As shown in FIG. 5, by providing at least one etching access 150 outside the anchoring region of the membranes 210, 220 and by providing at least one etching channel 153 between the etching access 150 and the cavity region 240, the SiO2 material present in the cavity region 240 can be removed in a sacrificial layer etching process. In this case, the SiO2 material of the second, third and fourth SiO2 layers 123, 125, 127 is removed between the first and second membrane structures 210, 220, between the first and second movable electrodes 251, 253 of the useful capacitor structure 250, between corresponding stop structures and optionally also between the first and second stationary electrodes 261, 262 of a reference capacitance structure 260.

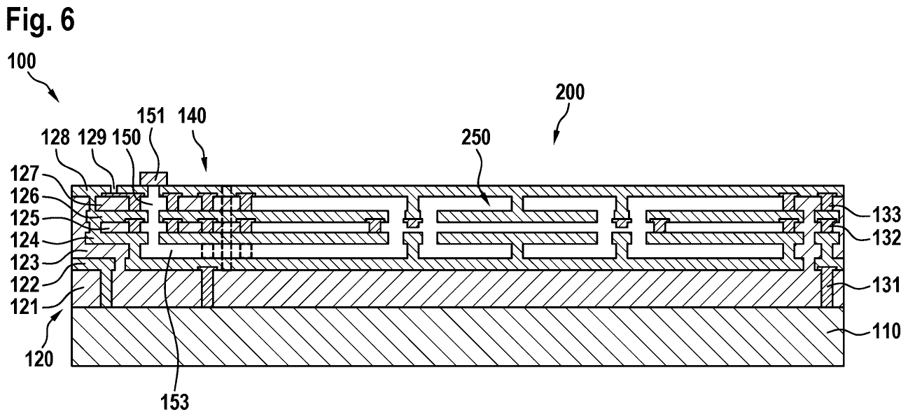

As further shown in FIG. 6, said at least one etching access 150 can subsequently be closed again with the aid of at least one layer deposition and/or by locally melting at least a part of the layer system 120, for example with the aid of a laser. In this case, a defined pressure can be set and/or a defined gas or gas mixture can be enclosed in the cavity region 240.

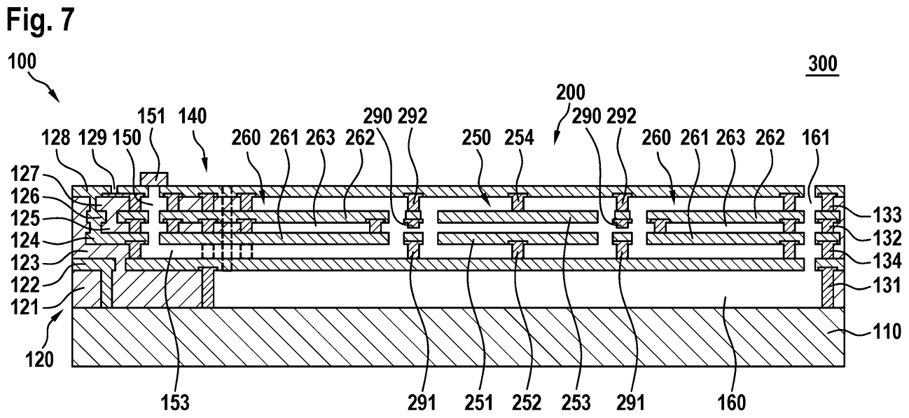

After closing the etching access 150, the layer system 120 can be at least partially removed down to the first SiO2 layer 121 around the first and second membrane structures 210, 220 and their anchoring regions using conventional structuring methods in order to realize a self-supporting sensing region 200 with two movable membranes 210, 220 between the first membrane structure 210, its anchoring regions, the at least one suspension structure 140 and the Si substrate 110 after the subsequent removal of the first SiO2 layer 121. A self-supporting sensor structure 200 of this kind is shown in FIG. 7. In this case, the suspension of the self-supporting region 200 realized by the at least one suspension structure 140 can be designed as desired with regard to the shape and/or the geometric dimensions. In this case, the electrical conductor tracks (not shown here) for connecting the electrodes of the useful capacitor 250 and the one or more reference capacitors 260 run through at least one of the suspension structures 140. In particular, in this case, electrically conductive layers of the layer stack forming the particular suspension structure 140 can serve as conductor tracks. As can be seen in FIG. 7, the at least one etching channel 153, which connects the cavity region 240 to the at least one etching access and via which the SiO2 sacrificial oxide layers are removed from the cavity region, also runs through the at least one suspension structure 140.

In principle, it is also possible to remove the sacrificial oxide layers in the cavity region 240 and beneath the first membrane structure 210 in a common etching process. In this case, it is possible, with the aid of conventional structuring methods, to first remove the layer system 120 at least partially down to the first SiO2 layer 121 (e.g., around the first and second membrane structures 210, 220 and their anchoring regions) and then to create the at least one etching access 150 for removing the sacrificial oxide layers 123, 125, 127 in the cavity region 240. In this variant, the sacrificial oxides from the cavity region 240 and the first SiO2 layer 121 between the first membrane structure 210, its anchoring regions, the at least one suspension structure 140 and the Si substrate 110 can be removed simultaneously. Subsequently, the at least one etching access 150 can be closed.

The provision of an etching access 150 outside the anchoring region of the membranes and the provision of at least one etching channel 153 which connects the etching access 150 to the cavity region 240 between the membrane structures 210, 220 can be dispensed with if at least one etching access 150 is provided in the anchoring region and/or in the second membrane structure 220, through which etching access the sacrificial oxide layers in the cavity region 240 can be removed and which is then closed again in a media-tight manner.

As is further shown by way of example in FIG. 7, it is also possible to provide the anchors 252, 254 of the movable electrodes 251, 253 of the useful capacitor 250 and the anchors 291, 292 of the mechanical stop structures 290 on the corresponding membrane structure 210, 220 not from polysilicon, but rather from SiRiN. In this case, the electrical connection of the movable electrodes 251, 253 can be made via flexible conductor track structures (not shown here) in the second and third polysilicon layers/levels 124, 126.

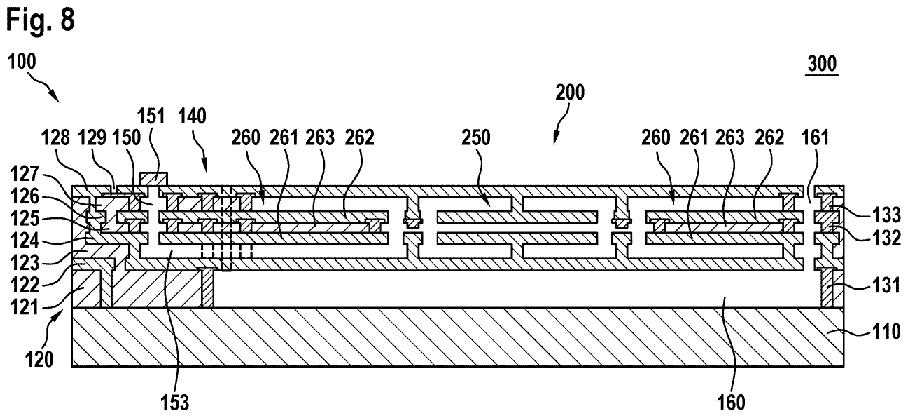

As FIG. 8 illustrates, as an alternative to the above-described embodiments, it is also possible not to remove the third SiO2 layer 125 between the stationary electrodes 261, 262 of the at least one reference capacitor 260. As a result, the capacitance of the reference capacitance structure 260 can be increased or, with the same capacitance, the reference capacitance structure 260 can be reduced in area, which in turn allows the movable electrode structures 251, 253 of the useful capacitor 250 to be made larger in area.

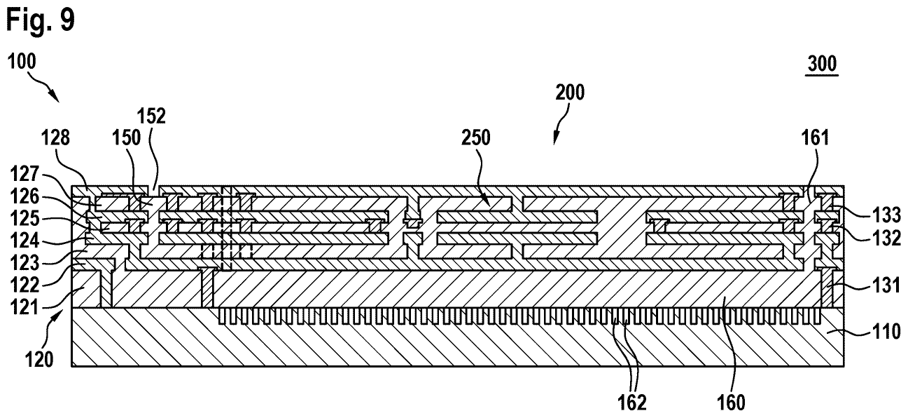

FIG. 9 illustrates another embodiment of the production process. As can be seen here, special structures 162 can also be introduced into the surface 115 of the Si substrate 110 under the layer system 120, at least in the region of the sensor structure 200, which structures are not completely filled with a first SiO2 layer 121. These structures 162, which are formed, for example, in the form of trenches or channels, preferably serve to distribute an etching medium for removing the first SiO2 layer 121 in the area as quickly as possible. In this way, complete removal of the first SiO2 layer 121 under the first membrane structure 210 can be carried out in a significantly shorter time. In FIG. 9, such structures 162 are shown by way of example in the form of regular trench structures.

Alternatively, channel-like SiO2-free structures for a rapid areal distribution of an etching medium for removing the first

SiO2 layer 121 can be provided within the first SiO2 layer 121 and for removing sacrificial oxide layers 123, 125, 127 in the cavity region 240 can optionally be provided, for example, within the second SiO2 layer 123.

In the embodiments described so far, an external etching access 150 for removing the SiO2 sacrificial layers in the cavity region 240 is described, which is located outside the stress-decoupled sensing region 200, which further extends at least through the fourth polysilicon layer 128 and which leads into the cavity region 240 via an etching channel 153 running in the suspension structure 140 serving for stress decoupling.

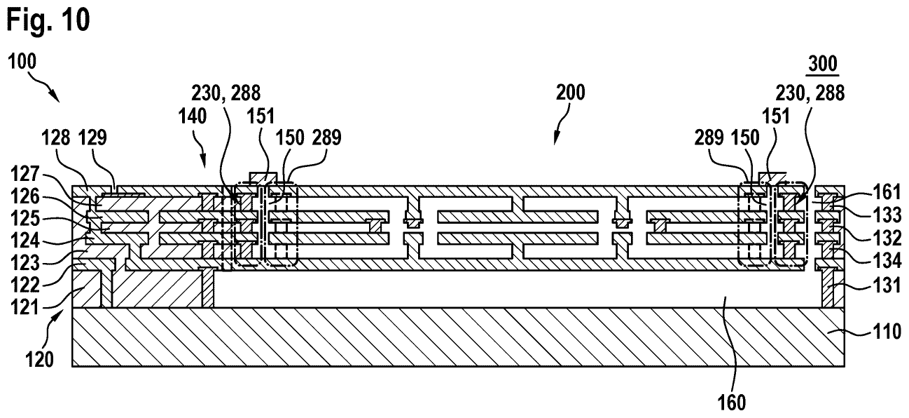

In principle, however, it is also possible to provide at least one etching access 150 on the later stress-decoupled sensing region 200 through at least the fourth polysilicon layer 128, via which etching access the SiO2 sacrificial layers 123, 125, 127 in the cavity region 240 can be removed and which can be closed by means of at least one layer deposition and/or a laser reseal process after the removal of the SiO2 sacrificial layers. FIG. 10 shows, by way of example, a pressure sensor 100 with a correspondingly designed sensing region 200. As can be seen here, the etching accesses 150 in this case are arranged as far as possible at the edge of the sensing region 200 in a region between inner and outer anchoring structures 289, 288 in order not to change or influence the properties of the second membrane structure 220 anchored to the inner anchoring structures 289. In this case, the number, size and distribution of the etching accesses 150 can vary depending on the application.

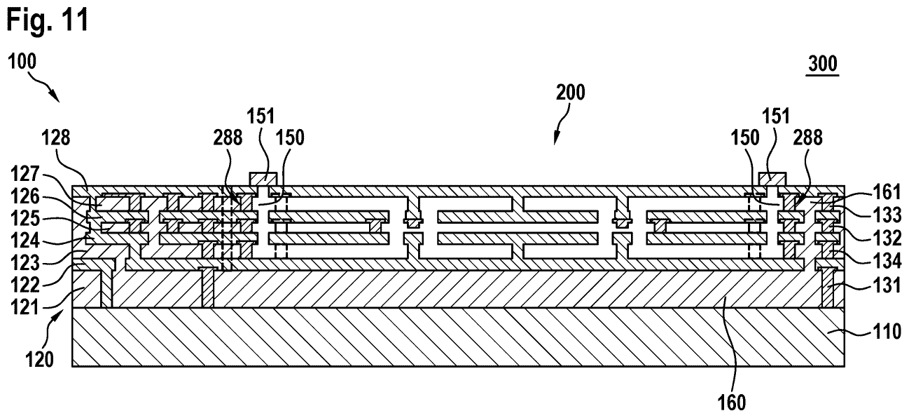

As can be seen in FIG. 11, between the internal etching accesses 150 and the center of the membrane structures 210, 220, between the individual polysilicon layers 124, 126, 128, further anchoring structures 289 for the first and the second membrane structure 210, 220, which consist of polysilicon and/or SiRiN, can be provided at least partially/in regions. In this case, the anchoring structures 289 can be aligned centrally to one another or at least partially deviate from a central alignment. The advantage of these optional anchoring structures 289 is that the closure region of the at least one etching access 150 can be placed between the membrane anchoring of the second membrane structure 220 and the lateral etch stop structures 288 made of polysilicon and/or SiRiN and provided at least on the periphery of the stress-decoupled sensing region, and negative influences of the closure region on the membrane properties of the second membrane 220 can thereby be avoided.

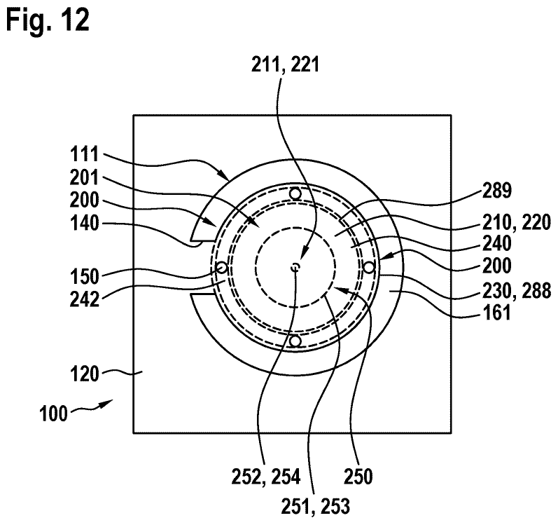

FIG. 12 is a plan view of a pressure sensor 100 which is designed according to the embodiment shown in FIGS. 10 and 11. The pressure sensor 100 shown here by way of example has a circular sensing region 200 which is suspended in a stress-decoupled manner via a suspension structure 140. As shown here by way of example, in an edge region of the sensing region 200, a total of four etching accesses 150 are provided, distributed along the periphery of the sensing region 200 and arranged between outer and inner anchoring structures 288, 289.

In principle, the peripheral contour of the stress-decoupled sensor structure/sensing region 200 can be arbitrary and does not have to correspond to the shape/contour of the first and/or second membrane surface 210, 220 defined by the further anchoring structures 289.

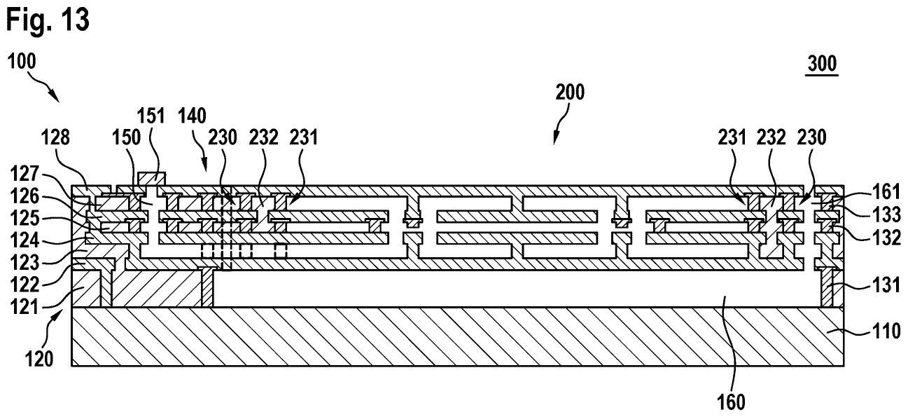

FIG. 13 shows a further possible embodiment in which, by providing further lateral etch stop structures 231 made of polysilicon and/or SiRiN between the individual polysilicon layers 124, 126, 128 within the sensing region 200, defined edge regions 232, in which SiO2 sacrificial layers are not removed, can be created. These edge regions 232 filled with SiO2 can be used, for example, to reinforce or make more stable the peripheral edge 230 of the sensor structure 200 formed by the outer etch stop structures.

In this case, the lateral etch stop structures made of SiRiN can not only be provided between polysilicon layers but also completely penetrate polysilicon layers, at least partially/in regions.

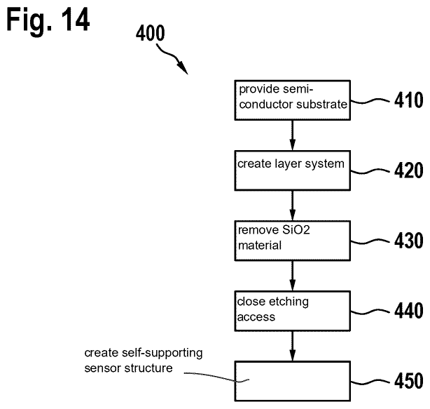

FIG. 14 shows a simplified flow diagram of the production method 400. In this case, in a first step 410, a semiconductor substrate 110 is first provided. In step 420, a layer system 120 is created on the semiconductor substrate 110 by depositing and structuring suitable materials, such as silicon dioxide, polysilicon and SiRiN (silicon-rich nitride), etc. By structuring the layers, a double membrane structure 210, 220 with a cavity region 240 is created in a functional region 111 of the layer system 120. In a further step 430, SiO2 material present in the cavity region 240 is removed via a previously created etching access 150. In step 440, the etching access 150 is closed by depositing material or by means of a laser reseal process. Finally, in step 450, a self-supporting sensor structure 200 is created by etching SiO2 material present beneath the double membrane structure 210, 220.

The design of the pressure sensor is not fully described in the above description and the associated drawings. Rather, the production method may include further steps that are apparent to a person skilled in the art. For example, after the closure of the at least one etching access for removing the sacrificial oxide layers in the cavity region, further process steps can be carried out in order to provide or implement, for example, bond pad structures, electrical conductor tracks and wiring levels, electrical isolation structures and isolation layers, diffusion barriers and diffusion barrier layers and the like. Furthermore, after each deposition, the deposited layer surface can optionally be planarized using, for example, a CMP process (chemical mechanical polishing) to create a flat surface. The deposited polysilicon layers can also optionally be doped at least locally or in regions using conventional methods in order to increase the electrical conductivity, and additional structures such as planar regions and/or at least one conductor track made of polysilicon can optionally be provided within the first silicon dioxide layer 121.

Since these are conventional methods, a detailed description has been omitted.

Although the present invention has been illustrated and described in detail by the preferred embodiments, the present invention is not limited to the disclosed examples. Rather, other variations can also be derived therefrom by a person skilled in the art without departing from the scope of the present invention.

1-16. (canceled)

17. A micromechanical pressure sensor, comprising:
a substrate with a layer system arranged on the substrate;
a sensor structure which is self-supportingly fastened to the layer system using at least one suspension structure, the sensor structure including a first membrane structure, a second membrane structure, and a cavity region that is arranged between the first and second membrane structures and is closed by a sidewall running in an edge region of the first and second membrane structures;
wherein the sensor structure has a useful capacitor which is arranged in the cavity region between the first and second membrane structures and has a first electrode fastened to the first membrane structure and a second electrode arranged between the first electrode and the second membrane structure and fastened to the second membrane structure.

18. The micromechanical pressure sensor according to claim 17, wherein the first and second electrodes are fastened to the first and second membrane structure, respectively, using at least one fastening structure in an inner region of the respective first and second membrane structure.

19. The micromechanical pressure sensor according to claim 17, wherein at least one reference capacitor with two oppositely arranged stationary electrodes is provided in an edge region of the cavity region/wherein each of the stationary electrodes is arranged between the other stationary electrode and one of the first and second membrane structures.

20. The micromechanical pressure sensor according to claim 19, wherein the reference capacitor is anchored at least partially or in regions in the sidewall and is self-supportingly arranged, aligned plane-parallel to the first and second membrane structures.

21. The micromechanical pressure sensor according to claim 20, wherein a silicon dioxide layer including a material of a third silicon dioxide layer is arranged between the stationary electrodes of the reference capacitor.

22. The micromechanical pressure sensor according to claim 17, wherein:
in the layer system, at least one etching access to the cavity region is formed outside a deflectable sensing surface of the second membrane structure, and
the etching access has a closure, which is: (i) formed by at least one material deposited on a surface of the layer system and/or (ii) introduced into the etching access and/or (iii) formed by at least one locally melted and re-solidified material of the layer system.

23. The micromechanical pressure sensor according to claim 22, wherein the etching access is arranged outside the sensor structure and is connected to the cavity region by an etching channel running through the at least one suspension structure.

24. The micromechanical pressure sensor according to claim 22, wherein the at least one etching access is arranged within the at least one suspension structure.

25. The micromechanical pressure sensor according to claim 22, wherein the at least one etching access is arranged in an edge region of the sensor structure.

26. The micromechanical pressure sensor according to claim 25, wherein the sensor structure has additional anchoring structures for fastening the first and second membrane structures, and wherein the etching access is arranged between the sidewall and the additional anchoring structures.

27. The micromechanical pressure sensor according to claim 17, wherein the sidewall is formed by outer anchoring structures, inner anchoring structures, and silicon dioxide material of silicon dioxide layers of the layer system remaining between the outer and inner anchoring structures.

28. The micromechanical pressure sensor according to claim 17, wherein, in the cavity region, at least one mechanical stop structure is fastened to at least one of the first and second membrane structures, the stop structure bringing about a limitation of a relative movement between the first and second membrane structures from a specified pressure value.

29. A method for producing a micromechanical pressure sensor, comprising:
providing a semiconductor substrate;
creating a layer structure on the semiconductor substrate by depositing and structuring layer;
creating, in a functional region of the layer structure, a sensor structure, which is connected to the rest of the layer structure via a suspension structure and includes a first membrane structure structured from a first polysilicon layer, a second membrane structure structured from a fourth polysilicon layer, and a cavity region delimited by a sidewall running in an edge region of the first and second membrane structures;
creating, in the cavity region, a useful capacitor with a first electrode structured from a second polysilicon layer and fastened to the first membrane structure, and a second electrode structured from a third polysilicon layer and fastened to the second membrane structure;
removing silicon dioxide layers arranged between the first, second, third, and fourth polysilicon layers using an etching method in the cavity region via at least one etching access having an opening in the fourth polysilicon layer; and
removing a first silicon dioxide layer arranged between the first membrane structure and a surface of the semiconductor substrate using an etching method.

30. The method according to claim 29, wherein the etching access is closed by: (i) depositing at least one material on a surface of the layer system and/or (ii) locally melting at least one material of upper layers of the layer system in a region of the etching access.

31. The method according to claim 29, wherein the removal of the silicon dioxide layers in the cavity region and the removal of the first silicon dioxide layer beneath the first membrane structure are carried out in a common etching process.

32. The method according to claim 29, wherein trench structures are created in the surface of the semiconductor substrate beneath the sensor structure, the trench structures being not completely filled during the deposition of the first silicon dioxide layer, and wherein the trench structures cause or promote a distribution of etching medium under the first silicon dioxide layer during the etching of the first silicon dioxide layer beneath the first membrane structure.
